(19) United States
(12) Patent Application Publication
(10) Pub. No.: US 2003/0026208 A1
(43) Pub. Date: Feb. 6, 2003

(54) Controlling levels of traffic in a telecommunications network with a relay node and a network node therefor

(76) Inventors: Dennis Bijwaard, Enschede (NL); B.F. Peelen, Enschede (NL)

Correspondence Address: Docket Administrator (Room 3J-219), Lucent Technologies Inc., 101 Crawfords Corner Road, Holmdel, NJ, 07733-3030, US

(21) Appl. No.: 09/919,046

(22) Filed: Jul. 31, 2001

(51) Int. Cl. H04J 1/16; H04J 3/14

(52) U.S. Cl. 370/236; 370/236.1

(57) ABSTRACT

A telecommunications network includes a plurality of user nodes, a relay node, and controller means. The controller means is operative to allocate resources so as to control levels of traffic transmitted form/to the user nodes via the relay node. Specifically, the controller means is operative to allocate a data transmission rate for traffic from user nodes via the relay node to user nodes which is twice that for traffic via the relay node in from or out of the network.

### TECHNICAL FIELD

The present invention relates to a telecommunications network, a network node therefor and a method of controlling levels of traffic.

### BACKGROUND OF THE INVENTION

Modern local area networks provide support for real-time multimedia and/or business critical applications, for example video conferencing. These Quality of Service (QoS)-enabled applications typically reserve a portion of the available bandwidth prior to a service/application session, and rely on the availability of the bandwidth throughout the session. The telecommunications network guarantees this bandwidth availability by restricting the throughput of other applications that do not have these QoS demands. The traffic generated by these non-QoS applications is called best effort traffic.

In shared medium networks such as shared Ethernet or wireless LAN bandwidth division is of a stochastic nature due to the fact that each node has equal chance to access the medium. Furthermore, the nodes are unaware of each other's traffic and QoS reservations, which means that reserved QoS traffic lacks protection from uncontrolled best-effort traffic within the same medium. This is illustrated in FIG. 1 below. When, for example, nodes 2,3 and 4 are sending a large amount of best effort traffic over the shared medium, QoS traffic from node 1 which should be sent with acceptable quality of service is jeopardized.

It has been recognised that bandwidth (and hence traffic) in a shared medium needs to be regulated at traffic sources. Regulating the traffic in this way has a beneficial effect on the effective available bandwidth since “collisions” are reduced between users wanting more bandwidth than they can have at a time.

A distinction can be made between shared medium with and without a relay. In a shared medium without a relay, each client can send data directly to other clients within that medium. In a shared medium with a relay, all data is transported from clients to the relay, which forwards it to the destination client(s). Ethernet is an example of a shared medium without a relay; wireless LAN (IEEE 802.11) with an access point is an example of a shared medium with a relay.

### SUMMARY OF THE INVENTION

The present invention provides a telecommunications network comprising a plurality of user nodes, a relay node, and controller means operative to allocate resources so as to control levels of traffic transmitted from/to the user nodes via the relay node, the controller means being operative to allocate a data transmission rate for traffic from user nodes via the relay node to user nodes which is up to twice that for traffic via the relay node in from or out of the network. The controller means can be a central controller or be distributed over the nodes.

The present invention also provides a method of controlling levels of traffic transmitted from/to user nodes via a relay node in a telecommunications network by allocating resources so as to to meet data transmission rate targets, including the step of setting a data transmission rate for traffic from one user node via the relay node to another user node which is twice that for traffic via the relay node in from or out of the network.

The present invention also provides a network node for a telecommunications network, the node comprising a regulator operative under the control of received control signals to limit the levels of traffic sent on by the node per unit time dependent on desired data transmission rate, the desired data transmission rate for traffic from user nodes via the relay node to user nodes being set at twice that for traffic via the relay node in from or out of the network.

### BRIEF DESCRIPTION OF THE DRAWINGS

A preferred embodiment of the present invention will now be described by way of example and with reference to the Figures, in which:

FIG. 1 is a schematic illustration of a known telecommunications network (prior art),

FIG. 2 is a schematic illustration of a telecommunications network according to an embodiment of the present invention, and

FIG. 3 is a further schemmatic illustration of the telecommunications network shown in FIG. 2.

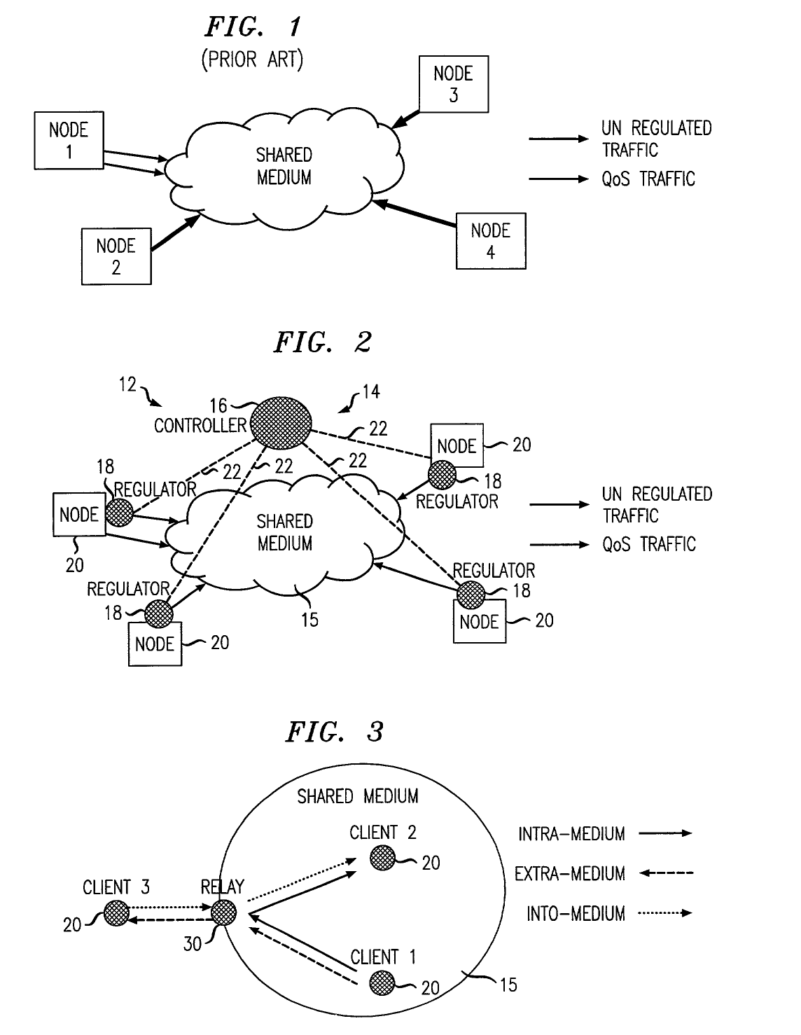

### DETAILED DESCRIPTION

There are provisions in the network to control the amount of best-effort and QoS traffic that is allowed within the network. As shown in FIG. 2 an example of such a provision is an admission control server 12 that restricts the QoS traffic in a network 14 including a shared medium 15 according to the network capacity. QoS traffic is therefore not controlled nor affected. The shared medium can be, for example, wireless Local Area Network (LAN) (CSMA/CA).

The admission controller 12 involves a central controller 16, regulators 18 at all user nodes 20 and control messages 22 between the regulators 18 and the central controller 16.

Each user node 20 is equipped with a regulator 18, which controls the amount of best effort and QoS traffic that is allowed to be sent by the node. The regulators 18 are centrally operated by the controller 16, which has knowledge about the current amount of QoS traffic and the total network capacity of the shared medium at any time. The controller 16 distributes the available network capacity that can be used for best effort traffic (total capacity minus present QoS traffic) among the nodes 20 which are active and controls the regulators 18 accordingly by sending control messages 22 to the regulators 18.

The regulators 18 inform the controller 16 on a regular basis about the amount of best effort traffic that is waiting to be transmitted. The controller 16 takes this into account when determining the setting (ie. the amount of best effort traffic allowed to be sent) of each regulator 18. The controller 16 sends, with the same regular interval, control messages 22 containing the current setting to the regulators 18.

Shared Medium with a Relay

As shown in FIG. 3, in a shared medium (network 15) with a relay, clients (user nodes 20) send data to the relay 30 (e.g. Access Point in Wireless LAN) that forwards it to the destination client residing either inside or outside the medium. As shown in FIG. 3, three traffic paths can be distinguished:

Intra-medium: Traffic with source and destination within the same medium.

Extra-medium: Traffic from within the medium to a client outside the medium.

Into-medium: Traffic from outside the medium into the medium.

In this scenario, it can be presumed that traffic in a shared medium is regulated at the source (this applies to both QoS and best-effort traffic); clients in a shared medium with a relay cannot send data directly to each other, that is a client has to send data via the relay to any other client; and all available best-effort bandwidth is divided among clients.

As can be seen from FIG. 3, intra-medium traffic can be considered as occupying the shared medium twice, compared to extra-medium traffic and into-medium traffic which only use the relay once.

Intra-medium traffic is thus distinguished from extra-medium and into-medium traffic when regulating all traffic in a shared medium with a relay. The entity (controller 16, not shown in FIG. 3) regulating the traffic allocates up to twice as much bandwidth for intra-medium traffic compared to extra-medium and into-medium traffic. This holds for both QoS and best-effort traffic.

This approach has advantages over two possible approaches where, unlike in the approach described above, no distinction is made between the different traffic paths. Bandwidth reservations could have been doubled for all traffic paths, but this would have wasted significant amounts of bandwidth for extra-medium and into-medium traffic. Alternatively, double bandwidth usage could simply not have been taken into account at all. In that case, clients could have sought to use more bandwidth than was available causing contention between clients with resultant collisions and hence packet loss, ultimately jeopardizing the QoS guarantees.

It will be appreciated that maximum use is thus made of available bandwidth, resulting in higher data throughput through the relay.

1. A telecommunications network comprising a plurality of user nodes, a relay node, and controller means operative to allocate resources so as to control levels of traffic transmitted from/to the user nodes via the relay node, the controller means being operative to allocate a data transmission rate for traffic from user nodes via the relay node to user nodes which is up to twice that for traffic via the relay node in from or out of the network.

2. A telecommunications network according to claim 1, in which at least some user nodes include a respective regulator of best effort traffic, said regulators being controlled by traffic level control signals sent by the controller.

3. A telecommunications network according to claim 2, in which the regulators are controlled by the control signals so as to set the maximum level of traffic sent per unit time by their respective nodes.

4. A telecommunications network according to claim 1, in which the traffic comprises best-effort traffic.

5. A telecommunications network according to claim 1, in which the traffic comprises traffic having a predetermined associated Quality of Service (QoS)

6. A telecommunications network according to claim 1, which is a wireless local area network.

7. A method of controlling levels of traffic transmitted from/to user nodes via a relay node in a telecommunications network by allocating resources so as to to meet data transmission rate targets, including the step of setting a data transmission rate for traffic from one user node via the relay node to another user node which is up to twice that for traffic via the relay node into or out of the network.

8. A method according to claim 7, in which control signals are sent to the nodes, the nodes being provided with regulators controlled by the control signals and operative to limit the level of traffic per unit time sent by the respective node.

10. A network node for a telecommunications network, the node comprising a regulator operative under the control of received control signals to limit the levels of traffic sent on by the node per unit time dependent on desired data transmission rate, the desired data transmission rate for traffic from user nodes via the relay node to user nodes being set at up to twice that for traffic via the relay node in from or out of the network.

11. A network node for a telecommunications network according to claim 10, the node being a relay node.

12. A network node for a telecommunications network according to claim 10, the node being a user node.
